(19) United States
(12) Patent Application Publication
(10) Pub. No.: US 2020/0282935 A1
(43) Pub. Date: Sep. 10, 2020

(54) Sensor Arrangement and Method for Activating Passenger Protection Means

(71) Applicant: Robert Bosch GmbH, Stuttgart (DE)

(72) Inventor: Alfred Kuttenberger, Weil Der Stadt (DE)

(21) Appl. No.: 15/774,554

(22) PCT Filed: Oct. 4, 2016
(86) PCT No.: PCT/EP2016/073646

§ 371 Date: May 30, 2020

(30) Foreign Application Priority Data
Nov. 9, 2015 (DE) 10 2015 221 992.5

(51) Int. Cl. B60R 21/015; G01S 17/42; G01S 17/89; G01S 7/48; B60R 21/017

(52) U.S. Cl. CPC B60R 21/0153; G01S 17/42; B60R 21/017; G01S 7/4802; G01S 17/89

(57) ABSTRACT

A sensor arrangement for optically sensing at least one object includes an emission unit, a controllable deflection unit, a reception unit, and an evaluation unit. The emission unit is configured to emit at least one light beam. The controllable deflection unit is configured to deflect the light beam. The reception unit is configured to receive at least a portion of the emitted and deflected light beam that is reflected by an object to be sensed. The evaluation unit is configured to evaluate the received at least portion of the light beam such that a 3D image is generated in order for the object to be sensed.

### PRIOR ART

Sensor arrangements for vehicles, which identify the presence of an occupant, are known.

Methods for actuating occupant protection means, which actuate the occupant protection means depending on the presence or the classification of an occupant, are also known.

Methods for actuating occupant protection means, which actuate the occupant protection means depending on an ascertained forward displacement, caused by inertia and as a consequence of a vehicle impact, are also known.

### DISCLOSURE OF THE INVENTION

The disadvantage of these methods is that the forward displacement of an occupant occurring as a consequence of an impact is not measured directly but estimated on the basis of the acceleration or deceleration captured by acceleration sensors.

Against this background, the present invention develops a sensor arrangement and methods for actuating occupant protection means according to the independent claims.

Such a sensor arrangement has an emission unit for emitting a light beam. Such an emission unit typically comprises a light source and suitable optics. A laser source as an emission unit would also be conceivable.

Moreover, the sensor arrangement comprises a controllable deflection unit for deflecting the emitted light beam. By way of example, such a deflection unit can be a mirror. So-called controllable micromirrors, which find use in projection technology, for example, have been found to be particularly advantageous.

Otherwise, such a sensor arrangement comprises a reception unit for receiving the emitted light beam when it is reflected by an object.

The reception unit consists of a photosensitive element which is tuned to the wavelength range of the emitted light beam. The photosensitive element captures the reflected light beams and converts these into electrical signals by means of a conversion unit. In an embodiment of the invention, a photodiode could be used to this end. Additionally, an optical element can still be disposed upstream of the photosensitive element, said optical element focusing the light beams and guiding them in a directed fashion onto the photosensitive element. In this context, the use of an appropriately designed lens is conceivable.

The reflected component of the emitted light beam is evaluated in an evaluation unit of the sensor arrangement in order to capture the object at which the light beam was reflected. Such an evaluation unit can comprise a microcontroller or an application-specific integrated circuit (ASIC).

In an advantageous embodiment, the sensor unit is connectable to an apparatus for actuating occupant protection means. In the present case, connectable should be understood to mean, inter alia, that the sensor arrangement and the apparatus are connected to one another by way of a communications means, such as a data bus, for instance a CAN bus, or a crash sensor interface, for example according to the SPI standard. Moreover, it is conceivable that the sensor arrangement is part of the apparatus.

In an embodiment of the sensor arrangement, the evaluation unit is designed in such a way that the evaluation unit determines a current position of the captured object.

An advantage of this embodiment in comparison with known apparatuses or methods for deriving or estimating the current position of the captured object, in particular of a vehicle occupant, is that the current position can be determined directly from the signals of the sensor arrangement and is not derived or estimated from the sensor signals.

In a further embodiment of the sensor arrangement, the evaluation unit is designed in such a way that the evaluation unit determines a current movement, in particular a current movement direction, of the captured object.

As a result of cyclically determining the position or as a result of continuously evaluating the sensor signals, it is possible to determine not only the current position but also the movement or the movement direction of the captured object, in particular of a vehicle occupant. In previous methods, or using previous apparatuses, the movement to be expected of an object, in particular of a vehicle occupant, was derived or estimated on the basis of the captured accelerations and by means of a model. As a result of using the present sensor arrangement, the movement is determined directly from the sensor signals. As a result, the movement and, in particular, the individual movement direction of the object, in particular of a vehicle occupant, are determined precisely and can be used in the optimized actuation of occupant protection means, such as airbags, belt pretensioners, active vehicle seats and the like.

In a next embodiment of the sensor arrangement, the evaluation unit is designed in such a way that the evaluation unit undertakes a classification of the captured object.

As a result of using the present sensor arrangement, it is possible to create, at least on the illumination side, a 3D model of the captured object, in particular of a vehicle occupant. The proportions and the alignment of the object can be derived from the 3D model. The proportions of the object, in particular, allow the size of the object to be determined directly. However, more accurate derivations of the weight of the object, in particular of a vehicle occupant, can also be implemented from the proportions in a simple manner.

Here, a classification should in the present case be understood to mean, inter alia, the determination of a size, in particular the assignment to a size class, or else the derivation of a weight, in particular the assignment to a weight class.

The methods according to the present invention are advantageous in that a more accurate actuation of the occupant protection means, or a better tuned actuation of the occupant protection means, can be undertaken.

This is achieved by virtue of the actuation methods running on the basis of sensor data of the sensor arrangement according to the present invention.

By way of example, it is advantageous to actuate the occupant protection means depending on the current position of the occupant to be protected. By way of the sensor arrangement according to the present invention, it is now possible to very accurately determine the current position of the occupant from the evaluation of the reflected component of the emitted light beam.

The movement of the occupant can be ascertained better from the continuous, accurate determination of the current position of the occupant. An actuation of the occupant protection means tuned to, or depending on, the ascertained movement of the occupant leads to an improved occupant protection level being ensured.

Taking account of not only the movement of the occupant during the actuation of the occupant protection means but also the ascertained movement direction is particularly advantageous. As a result, the occupant protection means can be adapted to the occupant to be protected in an optional fashion.

In an embodiment of the methods of the present invention, the occupant protection means are actuated depending on the classification of the occupant to be protected. The classification is performed by means of the evaluation unit of the sensor arrangement on the basis of the components of the emitted light beam that were reflected by the occupant.

An optimally tuned trigger of the occupant protection means in relation to the occupant to be protected is assisted by an assignment of the occupant to be protected to occupant classes, in particular to a size class or to a weight class, proceeding from the reflected and received components of the emitted light beams.

The embodiments of the sensor arrangement and of the methods of the present application, described above, should not be considered separately from one another; instead, it is understood from the nature of the technique that these embodiments combined with one another also form part of the present invention.

The invention will be explained further below on the basis of figures.

In detail:

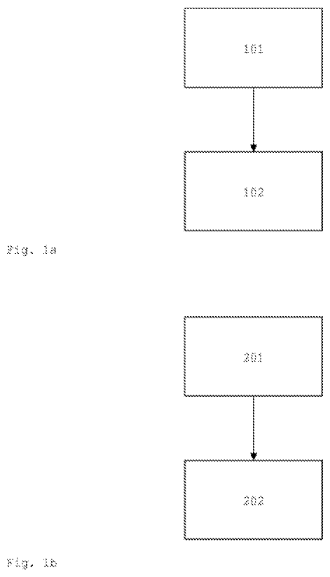

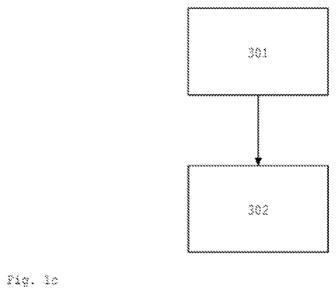

FIGS. 1a to c show flowcharts of the methods of the present invention

FIG. 1a shows a flowchart of an embodiment of the methods of the present invention.

In step 101, the reflected component of the emitted light beam is evaluated in order to ascertain a current position of a captured occupant. This evaluation can be effected by means of the evaluation unit of the sensor arrangement of the present invention.

In step 102, occupant protection means are actuated, wherein the ascertained, current position of the captured occupant is taken into account during the actuation; consequently, the occupant protection means are actuated depending on the ascertained, current position of the occupant.

FIG. 1b shows a flowchart of an embodiment of the methods of the present invention.

In step 201, the reflected component of the emitted light beam is evaluated in order to ascertain a current movement, in particular a current movement direction, of a captured occupant. This evaluation can be effected by means of the evaluation unit of the sensor arrangement of the present invention.

In step 202, occupant protection means are actuated, wherein the ascertained, current movement, in particular the ascertained, current movement direction, of the captured occupant is taken into account during the actuation; consequently, the occupant protection means are actuated depending on the ascertained, current movement, in particular the ascertained, current movement direction, of the occupant.

FIG. 1c shows a flowchart of an embodiment of the methods of the present invention.

In step 301, the reflected component of the emitted light beam is evaluated in order to classify a captured occupant. In the present case, a classification of a captured occupant should be understood to mean, inter alia, the ascertainment of capturable or derivable parameters of an occupant and the assignment thereof to a class. This includes, in particular, the capture or derivation of a size of the occupant and the assignment of the occupant to a size class depending on the captured size. In particular, this also includes the derivation of a weight of the occupant, for example from the captured size, and the assignment of the occupant to a weight class, depending on the derived weight. This evaluation, in particular the derivation, can be effected by means of the evaluation unit of the sensor arrangement of the present invention.

In step 302, occupant protection means are actuated, wherein the classification of the captured occupant is taken into account during the actuation; consequently, the occupant protection means are actuated depending on the classification of the occupant.

1. A sensor arrangement for optically capturing at least one object, comprising:
an emission unit configured to emit at least one light beam;
a controllable deflection unit configured to deflect the light beam;
a reception unit configured to receive at least one component of the emitted and deflected light beam that was reflected at the object to be captured; and
an evaluation unit configured to evaluate the received component in order to produce a 3D image so as to capture the object.

2. The sensor arrangement as claimed in claim 1, wherein the sensor arrangement is connectable to an apparatus configured to actuate an occupant protection device for a vehicle.

3. The sensor arrangement as claimed in claim 1, wherein the sensor arrangement is configured to ascertain a current position of the captured object.

4. The sensor arrangement as claimed in claim 1, wherein the evaluation unit is configured to ascertain one or more of a current movement and a current movement direction of the captured object.

5. The sensor arrangement as claimed in claim 1, wherein the evaluation unit is configured to undertake a classification of the captured object.

6. A method for actuating an occupant protection device for a vehicle, comprising:
ascertaining a current position of an occupant to be protected via a sensor arrangement configured to optically capture at least one object, the sensor arrangement including:
an emission unit configured to emit at least one light beam,
a controllable deflection unit configured to deflect the light beam,
a reception unit configured to receive at least one component of the emitted and deflected light beam that was reflected at the object to be captured, and
an evaluation unit configured to evaluate the received component in order to produce a 3D image so as to capture the at least one object, wherein the at least one object is the occupant; and
actuating the occupant protection device depending on the current position of the occupant.

7. A method for actuating an occupant protection device for a vehicle, comprising:
determining a parameter of an occupant to be protected via a sensor arrangement configured to optically capture at least one object, the sensor arrangement including:
an emission unit configured to emit at least one light beam,
a controllable deflection unit configured to deflect the light beam,
a reception unit configured to receive at least one component of the emitted and deflected light beam that was reflected at the object to be captured, and
an evaluation unit configured to evaluate the received component in order to produce a 3D image so as to capture the at least one object, wherein the at least one object is the occupant; and
actuating the occupant protection device depending on the parameter of the occupant.

8. (canceled)

9. The method as claimed in claim 7, wherein determining a parameter of an occupant to be protected includes ascertaining with the evaluation unit one or more of a current movement and a current movement direction of the occupant, and wherein the occupant protection device is actuated depending on the one or more of the current movement and the current movement direction of the occupant.

10. The method as claimed in claim 9, wherein the current movement of the occupant is a forward displacement.

11. The method as claimed in claim 7, wherein determining a parameter of an occupant to be protected includes undertaking with the evaluation unit a classification of the occupant, and wherein the occupant protection device is actuated depending on the classification of the occupant.
